(19) United States
(12) Patent Application Publication
(10) Pub. No.: US 2005/0132930 A1
(43) Pub. Date: Jun. 23, 2005

(54) Antique and faux finish powder coatings and powder coating methods

(76) Inventor: Grant E. Schlegel, Macungie, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 10/987,082

(22) Filed: Nov. 12, 2004

Related U.S. Application Data
(60) Provisional application No. 60/531,958, filed on Dec. 23, 2003.

(51) Int. Cl. C09C 1/22; C09C 1/28; C09C 1/44

(52) U.S. Cl. 106/415; 106/456; 106/466

(57) ABSTRACT

The present invention provides powder coating finishes comprising inter-mixed basecoat and color layers of coating powders, wherein the basecoat layer has a first color and one or more color layers has one or more accent color different from the first color. In the finishes, each of the first color and the one or more accent color is visible in the said finish to provide three-dimensional appearing antique look, swirl look and marbleized patterns. One or more of the coating powders used to form the finish may comprise a texture forming coating powder. Further, weatherable powder coating finishes comprise one or more protective powder coating layer between the substrate and basecoat color layer. In addition, the present invention provides methods for producing patterned powder coating finishes comprising applying to the substrate one or more basecoat coating powder layer having a first color, applying dry-on-dry one or more accent color coating powder layer over the basecoat powder layer, forming patterns in the resulting layers of coating powder, such as with one or more flat bristle brushes, and curing to form powder coating finishes.

The present invention relates to intermixed tone powder coating finishes and processes for making them. More particularly, the present invention relates to antique look, marbleized and swirl look powder coatings and to processes for making them.

### BACKGROUND

Marble surfaces and antique finishes appear pleasing to the view. Marble has however numerous drawbacks such as high cost, increasingly limited availability and poor weather resistance. Antiques must be aged for many years to appear antique or a finish must be treated, scuffed, abraded or stressed in a very labor intensive fashion to give it an antique look. To combine the aesthetic merits of these materials with low cost and a large variety of shapes and dimensions, it has been proposed to decorate metal, plastic, ceramic and other surfaces with liquid coatings and with powder coatings to imitate these finishes.

Processes providing marbleized faux liquid finishes by laying over a coating a photographically produced film or overlay or design containing film or overlay can provide swirl look or marbleized finishes not yet reproduced using solely coatings. However, such finishes with design or film overlays lack coating integrity, can delaminate, and lack the durability of an integral coating. Further, overlay or film layer designs on finishes appear two-dimensional and, thus, lack the depth and texture of a coating that can appear three-dimensional.

EP 0843598 B1 discloses methods for simulating wood or marble in a finish by coating metal surfaces comprising applying a layer of a first coloured powdered material to the whole surface to create a background layer, heating the background layer to a temperature that is below the polymerization temperature of this powder thus to fix the first powder to the surface, applying a second coloured powder to said coated surface in a pattern, said second coloured powder having a different colour than said first coloured powder, and heating the twice coated surface to a temperature of 180° C. for about 20 minutes to fix the second powder to said surface and to obtain the complete polymerization of the first and second powders. EP 0843598 B1 derives the benefits of powder coating methods, i.e. no volatile organic compound (VOC) content, ease of recycling, and high durability. However, the EP 0843598 B1 methods do not achieve a natural marble look, a swirl finish or an antique finish. Further, the EP 0843598 B1 finishes lack the appearance of depth and appear to have a shallow dotted texture or salt and pepper look much like that of a poor photocopy. Still further, one cannot blend the colours in the first and second coloured powders to form coatings having three or more shades.

There remains a need for powder coating finishes having a realistic and three-dimensional texture look, an antique look, a swirl look or a marbleized look and for a simple process that can provide a realistic antique look, swirl look or a marbleized look powder coatings. Further, there remains a need for antique or marbleized powder finishes that are weatherable. Accordingly, the present inventors have found simple powder coating methods and finishes produced thereby which meet these previously unmet needs.

### STATEMENT OF THE INVENTION

According to the present invention, powder coating finishes comprise intermixed basecoat and accent color layers of coating powders, wherein the basecoat layer has a first color and one or more of the color layers has one or more accent color different from the first color, wherein each of the first color and the one or more accent color is visible in the said finish. The inventive powder coating finishes comprise antique look, swirl look, marbleized, or three-dimensionally textured powder coatings formed from two or more coating powders having different colors, tints or hues. Finishes preferably comprise patterns formed from one or more texture forming coating powder to add depth and contrast to the finish, wherein the coating finishes will have an average local variation, as measured by profilometry, of from 20 to 100 μm.

Further, according to the present invention, methods for making antique look, swirl look, marbleized, or three-dimensionally textured powder coating finishes comprise applying dry on dry to the substrate one or more basecoat coating powder layer of a first color and one or more color coating powder layer of one or more accent color, wherein the color, tint or hue of the first color and of the accent color differ from one another, followed by forming patterns in the coating layers, such as by brushing, to obtain the desired pattern or appearance, and then curing all layers to form a powder finish. Added depth, contrast and enhancement of the pattern of the powder coating finishes may be provided by selecting one or more texture forming coating powder. If desired, outdoor or weatherable coatings may be made by a process comprising applying one or more primer layer or basecoat coating powder layer to the substrate and gelling or tacking the primer or basecoat coating powder layer prior to applying the basecoat coating powder layer to the substrate.

### BRIEF DESCRIPTION OF THE DRAWINGS

FIG. 1 depicts a digital image of a steel panel coated with the textured basecoat powder coating and smooth accent color coat powder coating used in Example 1, the coating showing an antique look three-dimensional pattern in gold.

### DETAILED DESCRIPTION

The method of the invention is applicable to any metal, ceramic, plastic, wood or glass surface to be decorated, providing finishes having the appearance of a natural surface, such as marble, or an antique look, swirl look or three-dimensionally textured look. The presently inventive powder coatings can appear to have “swirls” or “daubs”, which previously could only be made with liquid coatings.

For purposes of the present invention, the phrase “different colors, tints or hues” refers to any two or more coating powders that differ in color space value or RGB value, as measured by colorimetry.

For purposes of the present invention, the phrase “average local variation” refers to the average of the “local variation” or the distance from the height of the peak, as measured by profilometry, and a line connecting the two points marking the bottom of the valley adjacent each side of the peak, as measured by profilometry. The “average” is computed by summing up the local variations for all peaks measured by profilometry along a 1 cm or a 2 cm line in a finish and dividing the sum by the number of peaks.

As used herein, the phrase “coating powder”, “powder” or “powder coating composition” refers herein to the particulate material, and the term “powder coating” or “finish” refers to the coating applied to a substrate or article.

All ranges recited are inclusive and combinable. For example, an average particle size of 1.3 μm or more, for example, 1.5 μm or more, which may be 4.5 μm or less, or 4.0 μm or less, will include ranges of 1.3 μm or more to 4.5 μm or less, 1.5 μm or more to 4.5 μm or less, 1.5 μm or more to 4.3 μm or less, and 1.3 μm or more to 4.3 μm or less.

As used herein, unless otherwise indicated, the phrase “acrylic” includes acrylic, methacrylic, acrylate and methacrylate resins, and any mixture or combination thereof.

As used herein, the phrase “average particle size” refers to particle diameter or the largest dimension of a particle as determined by laser light scattering using a Malvern Instruments, Malvern, Pa., device located at the Rohm and Haas powder coatings Reading, Pa. Facility, Equipment Serial #: 34315-33.

As used herein, the “glass transition temperature” or T_{g} of any polymer may be calculated as described by Fox in Bull. Amer. Physics. Soc., 1, 3, page 123 (1956). The T_{g} can also be measured experimentally using differential scanning calorimetry (rate of heating 20° C. per minute, T_{g} taken at the midpoint of the inflection or peak). Unless otherwise indicated, the stated T_{g} as used herein refers to the calculated T_{g}.

As used herein, the phrase “Hot plate melt flow” (HPMF) refers to the flow of a 12.7 mm in diameter x 6 mm thick cylinder or pellet of a coating powder in a pyrometer (Model S-200 Thermo Electric Cure Plate, Thermo Electric Company, Cleveland Ohio) set to a certain temperature over a 5 minute period. Flow is measured linearly from the uppermost point of the original position of the specimen pellet on the hot plate to the extreme lower point of the pellet. Flow is measured while the specimen is on the hot plate using a steel rule.

As used herein, unless otherwise indicated, the phrase “melt viscosity” refers to the melt viscosity of a polymer or resin as measured in centipoises at 150° C. using a Brookfield Viscometer.

As used herein, unless otherwise indicated, the phrase “molecular weight” refers to the weight average molecular weight of a polymer as measured by gel permeation chromatography.

As used herein, unless otherwise indicated, the phrase “per hundred parts resin” or “phr” means the amount, by weight, of an ingredient per hundred parts, by weight, of the total amount of resin contained in a coating powder, including cross-linking resins.

As used herein, unless otherwise indicated, the phrase “polymer” includes, independently, polymers, oligomers, copolymers, terpolymers, block copolymers, segmented copolymers, prepolymers, graft copolymers, and any mixture or combination thereof.

As used herein, unless otherwise indicated, the phrase “resin” includes, independently, polymers, oligomers, copolymers, terpolymers, block copolymers, segmented copolymers, prepolymers, graft copolymers, and any mixture or combination thereof.

As used herein, the phrase “wt. %” stands for weight percent.

The desired finish may result, at least in part, from the chemistry of the coating powders selected. Heavy or deep three-dimensional textures, such as “old antique” and swirl or daub containing finishes, may be created by applying one or more texture forming coating powder as both the basecoat coating powder and the accent color coating powder. Further, moderate three-dimensional textures, such as “new antique”, swirl or daub containing, and marble finishes, may be created by applying one or more texture forming basecoat coating powder first followed by applying one or more smooth finish forming accent color coat coating powder. Still further, mild or shallow three-dimensional textures, such as low contrast “new antique”, swirl or daub containing, and marble finishes, may be created by applying one or more smooth finish forming basecoat coating powder first followed by applying one or more texture forming accent color coat coating powder. Both of the heavy and the moderate three dimensional textures have “average local variations” of from 20 to 100 μm. Alternatively, one or more basecoat coating powder, which is not a texture forming powder, and the one or more accent color coating powder, which is not a texture forming, powder can provide smooth or matte smooth marbleized, antique look or swirl look coatings that are not textured.

The powder coating may comprise one or more desired thermally or UV curing polymer or resin material chosen from polyester, unsaturated polyester, epoxy, acrylic, polyurethane, polyamide, polyolefin, polyvinylidene fluoride (PVdF), silicone, epoxy-polyester hybrid resins, epoxy-acrylic hybrid resins, polyurethane acrylate resins, epoxy acrylate (acrylic terminated epoxy), polyester acrylate resins, and mixtures and combinations thereof. Suitable resins or polymers will have a T_{g} of 40° C. or more, for example 45° C. or more.

Silicone resin powder coatings find use in making heat resistant coatings for barbecue grills. Polyesters useful in making weatherable coatings may comprise the reaction product of dicarboxylic acids comprising at least 75 mole %, based on the total moles of acid, of isophthalic acid and from 5 to 25 mole % of 1,4-cyclohexane dicarboxylic acid, based on the total moles of acid, with diols or polyols comprises mixtures of linear C₁ to C₆ glycols and neopentyl glycol.

Curing agents may be selected according to the polymer or resin material selected. Polyester or epoxy-polyester hybrid resins may be cured with triglycidyl isocyanurate (TGIC) or hydroxyalkylamide resins, such as β-hydroxyalkylamides curing agents. Unsaturated polyesters, such as those containing from 2 to 20 wt. % of maleate or fumarate repeat units, based on the weight of the unsaturated polyester, may be cured with from 1 to 50 phr of one or more crystalline crosslinker chosen from divinyl ether resin, (meth)acrylate functional resin, allyl ether resin, allyl ester resin, or mixtures and combinations thereof. One such UV curing agent is divinyl ether urethane, for example, the reaction product of vinyl ether and hexamethylene diisocyanate (HDI), isophorone diisocyanate (IPDI) or isocyanate functional condensates thereof with diols or polyols. Epoxy or epoxy-acrylic hybrid resins, such as bisphenol epoxy resins having an epoxide equivalent weight (eew) of from 150 to 1000, may comprise one or two component coatings cured with from 2 to 40 phr of aliphatic polyamines, aliphatic polyamine adducts of epoxy resin, carboxylic acids or their anhydrides, carboxylic anhydride adducts of epoxy resin, carboxylic acid functional polyesters or mixtures thereof. Polyurethanes may be cured with stoichiometric amounts of polyesters, polyester-epoxy resins, and epoxy resins. Acrylic polymers or resins, polyester acrylates and urethane acrylates can crosslink independently and may preferably be used without a crosslinking agent. Epoxy acrylates may be mixed with from 0.1 to 85 phr of unsaturated polyesters or with from 2 to 20 phr of UV curing crystalline crosslinkers.

In one embodiment of the present invention, coating powders that provide coatings may comprise epoxy resins in two component coating powders having, as a separate curing agent component, from 1 to 8 phr of curing agents chosen from imidazoles, such as methyl imidazole or phenyl imidazole, imidazole-epoxy resin adducts, and mixtures and combinations thereof.

Powder coating compositions may be used which provide textured finishes. Suitable texture forming coating powders can contain one or more texturing agents, such as core-shell copolymers or flexibilizers having rubbery cores, rubber particles, such as acrylonitrile butadiene copolymers, hydrophobically modified smectite clays, such as trialkylarylammonium hectorite and tetraalkylammonium smectite, crosslinked copolymers of acrylic and thermoplastic polymers which do not melt during processing, such as polypropylene, polytetrafluoroethylene (PTFE) in amounts of from 0.1 to 0.6 phr, blends of polyethylene with PTFE in amounts of from 0.8 to 6.0 phr, polyvinylidene fluoride (PVdF) or vinylidene fluoride copolymers. Alternatively, texture can be created by adding high oil absorption fillers to coating powders, such as fume silica or talc, and this texture can be enhanced by further adding 20 phr or more of fillers, such as barium sulfate. Still further, textures can be created with epoxy resins in two component coating powders having, as a separate curing agent component, from 1 to 8 phr of curing agents chosen from imidazoles, such as methyl imidazole or phenyl imidazole, imidazole-epoxy resin adducts, and mixtures and combinations thereof. With any texture finish forming powder coating, larger average particle sizes of the powder will create more intense texture looks.

The amount of texturing agent used and the average particle size of the powder coating determine the coarseness or fineness of the texture, with more texturing agent and coarser coating powders providing deeper textures. Except where otherwise noted, texturing agents may be used in the amount of from 0.5 to 50 phr, for example 1 to 10 phr.

“Hot plate melt flow” (HPMF) testing may be used to determine whether a powder coating finish is “textured.” Coating powders having an HPMF of 40 mm or less at 190.55° C. (375° F.), preferably 20 mm or less at 190.55° C. (375° F.), and, more preferably, 14 to 16 mm at 190.55° C. (375° F.). Limited HPMF refers to the ability of a coating powder to retain its powdery appearance during cure.

Fillers may be used to enhance coating hardness and to enhance texture. Fillers such as calcium carbonate, barium sulfate, wollastonite, china clay, diatomaceous earth, or mica may be added in amounts of 0 or more phr, for example, 10 or more phr or 20 or more phr, or 40 or more phr, and up to 120 phr, for example, up to 80 phr. Barium sulfate enhances texture depth and increases coating gloss, whereas calcium carbonate decreases coating gloss without enhancing texture depth.

Additives to aid or enhance the chemical and physical properties of the powder coating may be included, such as pigments, flow control agents, dry flow additives, anticratering agents, surfactants, light stabilizers, plasticizers, degassing agents, wetting agents, anti-oxidants, matting agents, and non ionic surfactants, such as fluorinated non ionic surfactants, such as FLUORAD™ FC-4430 fluoroaliphatic polymeric esters from 3M Specialty Materials, St. Paul, Minn., and the like.

Pigments, such as silicates, silicas, metallic pigments, such as aluminum flakes, gold and bronze, micas, iron oxide red, iron oxide yellow, lamp black, carbon black, mixed metal oxides, phthalocyanines, perylene reds, interference pigments which appear to have different colors from different viewing angles or combinations thereof may be used in amounts of 0 or more phr, for example, 10 or more phr or 20 or more phr, or 40 or more phr, and up to 120 phr, for example, up to 80 phr. Interference pigments, such as color shifting pigments that comprise multiple layers of reflective metal, e.g. aluminum or chromium, sandwiching layers of dielectric material, e.g. metal fluoride or metal oxide or magnetic layers, and absorptive layers, e.g. mica or coated mica, may be used in amounts of from 0.001 to 4.0 phr and, as a result of pattern forming, can form very intense multicolor patterns even when used as a lone coating powder layer. Suitable interference pigments may include, for example, CHROMAFLAIR™ light interference pigments from Flex Products, Inc., Santa Rosa, Calif.

The method of the present invention comprises applying dry on dry to the substrate one or more basecoat coating powder of a first color and one or more accent color coating powder of a second, wherein the color, tint or hue of the first and second color differ from one another, followed by forming a pattern, to obtain the desired pattern or appearance.

Depending on the nature of the surface to be decorated, the surface may be primed or pretreated, such as by pre-heating a wood or medium density fiberboard (MDF) substrate. For example, methods to make weatherable coating finishes, such as those suitable for outdoor use on outdoor furniture, outdoor lighting, or barbecue grills, comprise applying one or more protective basecoat coating powder to the substrate and gelling to coalesce the applied basecoat coating powder and to adhere the applied basecoat powder coating to the substrate. Protective basecoats seal the substrate and prevent it from exposure while forming the pattern and during the useful life of the substrate. Protective basecoat powders may be applied electrostatically, such as by Corona discharge guns, by fluidized bed coating, magnetic brush coating, or hot flock coating.

Gelling or tacking temperature at the substrate surface ranges from the melt temperature of the basecoat coating powder and up to just below the curing temperature of the coating powder, for example, from 45° C. to 110° C. Gelling or tacking may be carried out by heating the protected or primed substrate in sources of infrared (IR), near infrared (NIR), convection, or directional convection energy, or combinations thereof, for example, pairs or arrays of catalytic heating panels, infrared (IR) heating lamps, near IR (NIR) heating lamps between or among which the coated substrate is passed. Gelling or tacking may be carried out by heating at 45° C., for a period of 30 minutes or less, and up to 191° C. for 30 to 120 seconds.

After gelling or tacking the optional protective or primer layer, the surface temperature of the coated substrate is cooled to temperatures ranging from 100° F. (38° C.) to the T_{g} of either of the basecoat powder of the first color or the powder of the accent color. Cooling is effected by exposure to air or forced air at from ambient temperature to 38° C. The protective basecoat may have a thickness of from 12.7 to 50.8 μm (0.5 to 2.0 mil). The color of the protective basecoat coating powder can be the same as or can be different from the one or more basecoat coating powder of a first color or it may be a different color altogether.

If no protective or primer layer is applied to the substrate, the substrate itself may be preheated in the same manner as described in gelling to a substrate surface temperature ranging from 100° F. (38° C.) to the T_{g} of either of the basecoat powder of the first color or the powder of the accent color.

The one or more basecoat coating powder of a first color and the one or more coating powder of an accent color may be applied to the untreated, pretreated, primed or basecoat sealed substrate electrostatically, such as with Corona discharge guns, or by fluidized bed coating, magnetic brush coating, hot flock coating or other suitable means of powder coating. The powders in which the patterns are formed are applied dry on dry, without any heating or curing between their application.

The thickness of the coatings formed according to the present invention is not critical. However, the amount each of the one or more first color and accent color used will depend on the desired effect. For example, the one or more accent color influences the final color of the finish more than the one or more first color and, therefore, need only be applied in small amounts. However, the amount of accent color coating powder applied should be limited so as not to create a colorcoat completely blocking the basecoat after pattern forming. In general, the ratio of accent color to first color coating powder applied should range from 0.1 to 1.33:1.0, wherein in thinner coatings relatively more accent color powder may be applied relative to first color powder. The amount of one or more basecoat coating powder of a first color applied to the substrate should be sufficient that, if applied alone, it would make a cured film over the entire surface of the substrate having a thickness of from 12.7 to 152.4 μm (0.5 to 6.0 mil). The amount of one or more coating powder of an accent color or colors applied to the substrate should be sufficient that, if applied alone, it would to make a cured film over the entire surface of the substrate having a thickness of 2.54 μm (0.1 mil) or more, for example, 5.08 μm or more, or 12.7 μm (0.5 mil) or more and as thick as 76.2 μm (2.0 mils) or less, or 50.8 μm (2.0 mil) or less.

After application of the one or more basecoat of the first color and of the one or more powder of the accent color, a third layer of one or more coating powder of a third color different from the first color and the accent color may further be applied “dry on dry on dry” to the substrate.

Forming patterns in dry powder coatings may be carried out with mechanical devices or application equipment, thereby mechanically intermixing the coating powder layers to produce the dimensional affect. Patterns may be formed with mechanically or manually operated tools, such as brushes, dusters, compressed air, sponges, rollers, by suction or by coordinated wiping, such as by a combination of automated brushes, blades, pads, sponges etc. Patterns may be created manually in any pattern, e.g. to match a requested finish design or reproduce a master standard finish. Application equipment, such as corona charging electrostatic spray guns, may provide a starburst pattern, for example, by applying the one or more first color powder at a charge of from 70 to 100 kV and applying the powder of one or more accent color at a charge of from 50 to 60 kV. Preferably, pattern forming comprises brushing with a brush having flat bristles, such as with a No. 6 Chinese stencil brush, to allow swirling and intermixing of the basecoat and accent color coating powders to create the desired pattern.

Automatic pattern forming tools may comprise automatic arms adapted to treat the applied layers of powder, i.e. by applying a tool to the powder layer coated substrate and spinning, sweeping or stroking in any desired pattern or shape, e.g. circles, ellipses, zig-zags, back and forth strokes, one-way strokes, angled strokes of from 0 to 180 degrees at the elbow, random swirls, or arcs. Further, mechanical arms may be robotically controlled and programmed. Still further, automatic pattern forming tools may comprise applicators having pairs of cylindrical rotary pads for treating substrates, or may comprise rotary brushes, or sprayers for liquids, such as water, for partially removing the excess quantity of powder that has been applied to the substrate to leave on its surface the particular decoration to be obtained. Alternatively, patterns may be formed with a silkscreen stencil to reproduce the required decorative pattern after applying all of the powder.

Once all coating powders have been applied, they are thermally or UV cured using convection, IR, NIR, or combinations thereof, using appliances as disclosed in gelling primers or protective basecoats. Thermal curing may be carried out in a convection oven set, for example, at from 300 to 400° F. (149 to 204.4° C.) for a period of from 5 to 20 minutes The applied coatings may also be UV cured, such as with a 200 to 600 watt mercury-gallium lamp, by exposure to a total curing energy ranging from 0.1 to 3.0 Joules/cm², preferably from 1.0 to 3.0 Joules/cm². The entire assembly is baked, for example, at 180° C. for 20 minutes.

The inventive process may be made continuous or may be carried out from station to station.

Substrates coated may include wood, plywood, MDF, aluminum, steel, iron, brass, plastic, paper, cardboard and masonite. Examples of substrates treated according to the method of the invention may include grills, indoor and outdoor furniture, extruded aluminum profiles for windows or window, wall, floor and ceiling trim or molding, metal section bars for window frames, metal plates for household electrical appliances, chipboard or MDF panels for kitchens, indoor or outdoor furniture elements, metal sheets and section bars for use automobiles, and in naval and aeronautical applications.

### EXAMPLE 1

### Development of Faux Finish

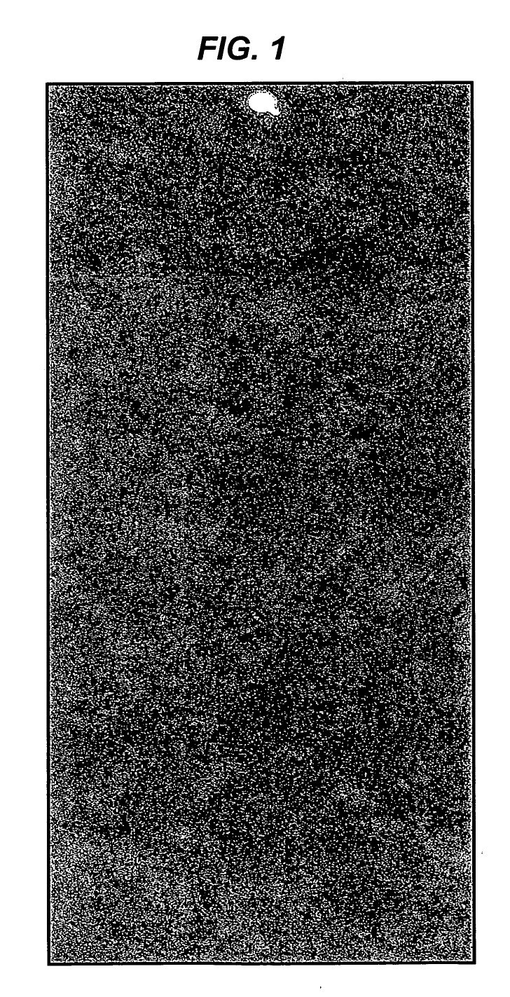

To create the antique finish depicted in FIG. 1, the black texture basecoat coating powder shown in Table 3 was electrostatically applied to a steel Q-panel to a depth of 2.0 mil (50.8 μm) and the resulting coating layer was gelled or tacked to the substrate, but not cured, at 375° F. (190.55° C.) for 90 seconds. To this gel layer was electrostatically applied the same black texture basecoat coating powder to a depth of from 2 to 3 mil (50.8 to 76.2 μm). To the resulting dry layer of black texture was electrostatically applied gold accent color coating powder shown in Table 2 to a depth of 0.5 mil (12.7 μm). Then, the random three-dimensional pattern shown in FIG. 1 was created with a No. 6 Chinese stencil brush having flat bristles. The resulting three-layers of powder coating was cured in a convection oven at 375° F. (190.55° C.) for 15 minutes.

TABLE 1
PROPERTIES OF BASECOAT COLOR
AND ACCENT COLOR POWDERS

| | BASECOAT | ACCENT |
|---|---|---|
| | POWDER | POWDER |
| TEST | Black Texture | Gold |
| HPMF @ 375 F. | 14-16 | 70-80 |
| 60 Degree gloss of | 5-10 | 70-80 |
| powders | | |
| Retention on 325 mesh | 40-55 | 30-40 |

TABLE 2
GOLD ACCENT COLOR COATING POWDER

| INGREDIENT | PHR |
|---|---|
| Hydroxyl functional polyester | 87 |
| Caprolactam blocked isophorone | 13 |
| diisocyanate (IPDI) curing agent | |
| acrylic flow modifier | 1.4 |
| Benzoin degasser | 0.8 |
| Barium sulfate filler | 20 |
| Pigments/metallic | 6 |
| TOTAL | 128.2 |

TABLE 3
BLACK TEXTURE BASECOAT COATING POWDER

| INGREDIENT | PHR |
|---|---|
| carboxyl functional polyester | 93 |
| Triglycidyl isocyanurate crosslinker | 7 |
| acrylic flow modifier | 1.4 |
| PTFE/Polythene blend texturizing agent | 7 |
| Nepheline Syenite Rheological flow reducer | 40 |
| pigments | 2 |
| TOTAL | 150.4 |

### EXAMPLE 2

### Profilometry of a Textured Finish

Profilometry was measured on a powder coated steel O-panel coated with a 2.0 mil (50.8 μm) protective layer of beige TGIC-polyester, and a cured dry-on-dry random texture pattern coating comprising 2 to 3 mil (50.8 to 76.2 μm) of beige TGIC-polyester overlayed dry with 0.5 mil (12.7 μm) of a brown and red multi-component TGIC-polyester texture coating. Six 2.0 cm strips of this coating were randomly selected for profilometry measurement and the measurements of all six strips appeared very similar to one another. The data from one such strip is presented in Table 4, below.

Profilometry was measured on a powder coated steel Q-panel coated with a cured dry-on-dry random swirl pattern coating comprising 2.0 mil (50.8 μm) of green TGIC-polyester, TGIC-polyester overlayed dry with 1.5 mil (38.1 μm) of a metallic gray TGIC-polyester texture coating. Six 2.0 cm strips of this coating were randomly selected for profilometry measurement and the measurements of all six strips appeared very similar to one another. The data from one such strip is presented in Table 5, below.

[image]

As shown in the Table 4 profilometry data, the local variation measured in the textured coating ranged from 20 to 100 micron (peak minus average of 2 valleys); average peak height was 39 micron. In the coating, the average peak-to-peak distance was 0.74 mm (1.4 peaks/mm strip length). This coating exemplifies heavy texture.

[image]

In the Table 5 profilometry data, the local variation measured in the smooth coating ranged from 1 to 5 microns (peak minus average of 2 valleys); average peak height was 3.7 micron. In the coating, the frequency of peaks: was 0.95 mm (1.1 peaks per mm strip length).

As shown in Tables 4 and 5, texture over texture powder coatings provide patterns with enhanced depth or local variation when compared to smooth over smooth powder coatings.

1. A powder coating finish comprising intermixed basecoat and color layers of coating powders, wherein the said basecoat layer has a first color and one or more of the said color layers has one or more accent color different from the said first color, wherein each of the said first color and the said one or more accent color is visible in the said finish.

2. A powder coating finish as claimed in claim 1, wherein one or more of the said basecoat and color layers comprises a texture forming coating powder.

3. A powder coating finish as claimed in claim 2, wherein the said finish has an average local variation, as measured by profilometry, of from 20 to 100 μm.

4. A powder coating finish as claimed in claim 1, wherein the said accent color comprises one or more metallic pigments, silicates, silicas, micas, iron oxide red, iron oxide yellow, lamp black, carbon black, mixed metal oxides, phthalocyanines or interference pigments.

5. A weatherable powder coating finish as claimed in claim 1, further comprising a protective powder coating layer between the said substrate and the said basecoat layer.

6. A method for producing a coating finish comprising:
providing a basecoat coating powder having a first color and one or more color coating powder having one or more accent color differing in color or hue from the said first color,
applying the said basecoat powder coating composition to a substrate to form a basecoat powder layer;
applying dry-on-dry the said one or more accent color coating powder layer over the said basecoat powder layer;
forming patterns in the said powder layers; and,
curing the said powder layers to form a powder coating finish.

7. A method as claimed in claim 6, wherein the said forming patterns comprises brushing, blowing on, sponging, rolling, or stamping the said coating or reducing the voltage used in electrostatic application of the said one or more color coating powder.

8. A method as claimed in claim 6, wherein one or more of the said basecoat coating powder or color coating powder comprises a texture forming coating powder.

9. A method as claimed in claim 6, wherein the said forming patterns brushing with a brush having flat bristles.

10. A method as claimed in claim 6, further comprising:
applying a primer layer or basecoat coating powder layer to the said substrate and gelling or tacking the said primer or basecoat coating powder layer prior to applying the said basecoat powder layer to the said substrate.
